(19) United States
(12) Patent Application Publication
(10) Pub. No.: US 2012/0010307 A1
(43) Pub. Date: Jan. 12, 2012

(54) Expandable Beads of a Compostable or Biobased Thermoplastic Polymer

(75) Inventors: Adam R. Pawloski, Lake Elmo, MN (US); Jeffrey J. Cernohous, Hudson, WI (US); Kent Kaske, Woodbury, MN (US)

(73) Assignee: Lifoam Industries, Hunt Valley, MD (US)

(21) Appl. No.: 13/178,272

(22) Filed: Jul. 7, 2011

Related U.S. Application Data
(60) Provisional application No. 61/362,004, filed on Jul. 7, 2010.

(51) Int. Cl. C08J 9/232; C08J 9/228; C08J 9/18; C08J 9/14; C08L 67/04

(52) U.S. Cl. 521/58; 521/98; 521/94; 521/88; 521/97; 521/60

(57) ABSTRACT

The invention provides a composition and process for producing expandable beads from a compostable or biobased thermoplastic polymer. A key aspect of this invention is the ability to incorporate sufficient amounts of hydrocarbon blowing agent into the matrix of the compostable or biobased polymer. The following process may be used. First, the raw materials of compostable or biobased polymers, hydrophobic additive, and other additives are mixed by melt processing techniques. Next, a hydrocarbon blowing agent is added to the admixture, either by addition into the melt or by impregnation into the solid, to produce an expandable bead. Small, lightweight, foamed beads are produced by heating the expandable bead. Then, the expanded beads are subsequently used in conventional operations for molding into foamed articles.

### CROSS REFERENCE TO RELATED APPLICATION

This application is based upon and claims benefit of copending and co-owned U.S. Provisional Patent Application Ser. No. 61/362,004 entitled “Expandable Beads of a Compostable Thermoplastic Polymer”, filed with the U.S. Patent and Trademark Office on Jul. 7, 2010 by the inventors herein, the specification of which is incorporated herein by reference.

### BACKGROUND

1. Field of the Invention

The present invention relates generally to compostable or biobased material compositions and to novel methods for producing lightweight, compostable or biobased foams for various expandable materials. In particular, the present invention discloses methods for producing foams using melt processing techniques to blend compostable or biobased materials and blowing agents. The compositions and processes are useful for the production of a variety of products.

2. Description of the Background

Polymeric foams include a plurality of voids, also called cells, in a polymer matrix. By replacing solid plastic with voids, polymeric foams use fewer raw materials than solid plastics for a given volume. Thus, by using polymeric foams instead of solid plastics, material costs can be reduced in many applications.

The material used for expandable polystyrene (EPS) is typically an amorphous polymer that exhibits a glass transition temperature of about 95° C. and a melting temperature of about 240° C. The process of converting EPS resins into expanded polystyrene foam articles requires three main stages: pre-expansion, maturation, and molding. Expandable beads produced from polystyrene and a blowing agent are made, and then expanded by steam in a pre-expander. The purpose of pre-expansion is to produce foam particles of the desired density for a specific application. During pre-expansion, the EPS beads are fed to a pre-expander vessel containing an agitator and controlled steam and air supplies. The introduction of steam into the pre-expander yields two effects: the EPS beads soften and the blowing agent that is dispersed within the EPS beads heats to a temperature above its boiling point. These two conditions cause the EPS beads to expand in volume. The diameter of the particles increases while the density of the resin decreases. The density of pre-expanded granules is about 1000 kg/m³, and that of expanded beads lies in the range of 20 to 200 kg/m³; depending on the process, a 5 to 50 times reduction in density may be achieved.

Maturation serves several purposes. It allows the vacuum that was created within the cells of the foam particles during pre-expansion to reach equilibrium with the surrounding atmospheric pressure. It permits residual moisture on the surface of the foam particles to evaporate. And, it provides for the dissipation of excess residual blowing agent. Maturation time depends on numerous factors, including blowing agent content of the original resin, pre-expanded density, and environmental factors. Pre-expanded beads that are not properly matured are sensitive to physical and thermal shock. Molding of such beads before maturation may cause the cells within the particles to rupture, thereby producing an undesirable molded foam part.

Once the pre-expanded beads have matured, they are transferred to a molding machine containing one or more cavities that are shaped like the desired molded foam article(s). The purpose of molding is to fuse the foam particles together into a single foam part. Molding of EPS may follow a simple sequence: first, fill the mold cavity with pre-expanded beads; heat the mold by introducing steam; cool the molded foam article within the mold cavity; and eject the finished part from the mold cavity. The steam that is introduced to the molding machine causes the beads to soften and expand even further.

The combination of these two effects in an enclosed cavity allows the individual particles to fuse together into a single solid foam part.

There is an increasing demand for many plastic products used in packaging to be biodegradable, for example trays in cookie and candy packages. Starch films have been proposed as biodegradable alternatives for some time. U.S. Pat. No. 3,949,145 describes a starch/polyvinyl alcohol/glycerol composition for use as a biodegradable agricultural mulch sheet.

A common approach to creating biodegradable products is to combine polylactic acid (PLA) with starch to create a hydrolytically degradable composition. Difficulties have been encountered in producing starch based polymers particularly by hot melt extrusion. The molecular structure of the starch is adversely affected by the shear stresses and temperature conditions needed to plasticize the starch and pass it through an extrusion die. For most products, foaming has to be avoided, which generally requires close attention because of the water content of the starch. Foaming has been avoided by degassing the melt prior to exiting the die as suggested in U.S. Pat. Nos. 5,314,754 and 5,316,578. The latter patent also avoids adding water to the starch. As explained in U.S. Pat. No. 5,569,692, by not drying the starch and avoiding the addition of water, the starch can be processed at temperatures between 120° C. and 170° C. because the water bound to the starch does not generate a vapor pressure such as to require high pressures. Another approach to improving the melt processability of starch is to provide an additive as in U.S. Pat. No. 5,362,777 that reduces the melting point of the starch.

Certain patents or patent applications disclose the use of pentane as a blowing agent. However, in those methods utilizing pentane, the PLA is necessarily combined with an adjuvant or polymer to create an expandable PLA. U.S. Pat. No. 6,593,384 to Anderson et al. describes expandable particles produced using broad polymer materials and a physical blowing agent. U.S. Pat. No. 7,226,615 to Yuksel et al. describes an expandable foam based on broad disclosure of biomaterials combined with a bicarbonate blowing agent. U.S. Published Patent Application No. 2006/0167122 by Haraguchi et al. describes expandable particles derived from the combination of PLA, a blowing agent, and a polyolefin wax.

It is generally accepted that there is a trade off between small cell size and optimal material properties as blowing agent levels in microcellular polymeric material are altered.

### SUMMARY

Accordingly, it is an object of the present invention to provide a compostable or biobased expandable bead that avoids the disadvantages of the prior art.

It is another object of the present invention to provide an environmentally ‘green’ replacement material for expandable polystyrene (EPS). A related object of the present invention is to provide a compostable, expandable bead formulation.

It is another object of the present invention to provide a biobased, expandable bead formulation.

Another object of the present invention is to provide a foamed bead that is capable of composting.

It is another object of the present invention to provide a method for producing compostable or biobased expandable beads using melt processing techniques.

It is another object of the present invention to provide a compostable or biobased, foamed bead that can be processed using conventional molding equipment.

A further object of the invention is to provide a compostable or biobased, foamed bead that can be fabricated into a three-dimensional shape.

These and other objects of the present invention are accomplished by providing a composition and process for producing expandable beads from a compostable or biobased thermoplastic polymer. One aspect of this invention is the ability to incorporate sufficient amounts of hydrocarbon blowing agent into the matric of the compostable polymer, such as PLA. In one embodiment, the melt processable composition includes additional hydrophobic additives to increase solubility of the blowing agent in the composition. The foamed beads of this invention can be further processed using conventional molding equipment to provide a lightweight, compostable or biobased, foamed article. Articles of this invention have utility in applications where conventional expandable polystyrene (EPS) is utilized today, including those applications relating to protective packaging, sound dampening, and thermal insulation.

### DETAILED DESCRIPTION OF EXEMPLARY EMBODIMENTS

The invention summarized above and defined by the enumerated claims may be better understood by referring to the following description. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

The present invention is directed toward a variety of products that are made of compostable or biobased materials. The compostable or biobased materials can include either or both of an externally or an internally modified polymer composition, as those terms are described below.

Degradability

Biodegradability refers to a compound that is subject to enzymatic decomposition, such as by microorganisms, or a compound, portions of which are subject to enzymatic decomposition, such as by microorganisms. In one instance, for example, a polymer such as polylactic acid can be degraded by hydrolysis to individual lactic acid molecules that are subject to enzymatic decomposition by a wide variety of microorganisms. Microorganisms typically can consume carboxylic acid-containing oligomers with molecular weights of up to about 1000 daltons, and preferably up to about 600 daltons, depending on the chemical and physical characteristics of the oligomer.

Biobased means materials that are synthesized from biological sources and refers to ingredients that reduce the use of non-renewable resources by integrating renewable ingredients as a replacement for at least a portion of the petroleum used in making EPS. Biobased ingredients can be used in many products without hindering their performance.

Composting is the biological process of breaking down organic waste into a useful substance by various microorganisms in the presence of oxygen.

Preferably, the polymer in the present materials breaks down by composting. The degradation characteristics of the polymer in the present materials depend in large part on the type of material being made with the polymer. Thus, the polymer needs to have suitable degradation characteristics so that when processed and produced into a final material, the material does not undergo significant degradation until after the useful life of the material.

The polymer of the present materials is further characterized as being compostable within a time frame in which products made from the materials break down after use. The materials of this invention degrade in a time period of a few weeks to a few years, whereas similar mass-produced, nondegradable products typically require decades to centuries to break down naturally.

The present invention describes a composition and process for producing expandable beads from a compostable or biobased thermoplastic polymer. The intended purpose of such compostable or biobased thermoplastic polymer material is to replace expandable polystyrene (EPS) with a foamed bead produced from a compostable or biobased polymer in the construction of foamed articles. Ideally, one would substitute EPS with a compostable or biobased polymer of the same chemical and physical properties.

The compostable or biobased polymers of this invention are produced by melt processing compostable or biobased polymers with a blowing agent and, optionally, additives that modify the rheology of the compostable or biobased polymer, including chain extenders and plasticizers. The compostable or biobased polymers may include those polymers generally recognized by one of ordinary skill in the art to decompose into compounds having lower molecular weights. Non-limiting examples of compostable or biobased polymers suitable for practicing the present invention include polysaccharides, peptides, polyesters, polyamino acids, polyvinyl alcohol, polyamides, polyalkylene glycols, and copolymers thereof.

The expandable beads of this invention are produced using a compound comprising a compostable or biobased polyester and a blowing agent. Additives including plasticizers and chain extenders are optionally included in the compostable or biobased composition. Expandable beads can be produced using conventional melt processing techniques, such as single and twin-screw extrusion processes. In one embodiment, the compostable or biobased polymer is mixed with a hydrophobic additive by melt processing to produce pellets. These pellets are then impregnated with a blowing agent to make expandable beads. The expandable beads are then heated to cause foaming, producing foamed beads. The foamed beads are then molded into articles. In another embodiment, melt processing is used to mix compostable or biobased polymer, hydrophobic additive, and blowing agent to produce an expandable beads directly from the melt processing operation. In this case, extrudate from the die must be cooled rapidly to lock in the blowing agent so that it does not escape and foaming does not occur. It is desired that foaming occurs at a controlled time in a pre-expander operation by heating the expandable beads to produce foamed beads. The foamed beads are then molded. Preferably, the resulting foamed bead has a specific gravity less than 0.15 g/cm³. More preferably, the foamed bead has a specific gravity of less than 0.075 g/cm³, and most preferably less than 0.05 g/cm³. In a preferred embodiment, more than 50 wt % of the foam is compostable, as determined by ASTM D6400. More preferably, more than 80% of the foam is compostable. In a most preferred embodiment, greater than 95% of the foam is compostable.

In one aspect, the compostable or biobased polymer is a polyester. Non-limiting examples of polyesters include polylactic acids, poly-L-lactic acid (PLLA), poly-D-lactic acid (PDLA) and random or stereoregular copolymers of L-lactic acid and D-lactic acid, and derivatives thereof. Other non-limiting examples of polyesters include polycaprolactone, polyhydroxybutyric acid, polyhydroxyvaleric acid, polyethylene succinate, polybutylene succinate, polybutylene adipate, polymalic acid, polyglycolic acid, polysuccinate, polyoxalate, polybutylene diglycolate, and polydioxanone.

In this invention, a compostable or biobased polymer is melt processed with hydrophobic additives, and mixed or impregnated with a hydrocarbon blowing agent to produce an expandable bead. The expandable bead can be converted to a foamed bead by heating, thus expanding the bead by the volatilization of the blowing agent and softening of the material. Blowing agents are materials that can be incorporated into the melt processable composition (e.g., the premix of the additives, polymeric matrix, and/or optional fillers, either in melt or solid form) to produce cells through the release of a gas at the appropriate time during processing. The amount and types of blowing agents influence the density of the finished product by its cell structure. Preferred hydrocarbon blowing agents for this invention include propane, butane, pentane, hexane, heptane, and octane.

The invention allows for the conversion of an existing EPS manufacturing plant to produce a foamed article based on a compostable plastic. The chemical composition of the plastic is designed to allow for improved solubility of hydrocarbon blowing agents.

Preferred polymer resins for this invention include known compostable materials derived from biological sources (e.g. biopolymer resins), but biodegradable synthetic polymers capable of being composted are also acceptable. The biopolymer polylactic acid (PLA) is the most preferred example due to its known compostability and its origins from agricultural (e.g. corn) feedstocks. Both amorphous and semi-crystalline PLA polymers can be used. Examples of compostable or biobased polymers include Ingeo 2002D and Ingeo 4060D grade plastics and Ingeo 8051D grade foam from NatureWorks, LLC, and Cereplast Compostable 5001.

In some embodiments, the plastic formulation of interest may be compounded, as required, into a homogeneous material for extrusion. As appropriate, the plastic will be pelletized and optionally ground and classified into particles of a predetermined size, for example 0.25 mm diameter. The polymer pellets may then be added into a stirred pressure tank with water to produce a slurry. Solution stabilizers, such as surfactants or salts, may be added to inhibit coagulation of pellets and to promote diffusion of hydrocarbon blowing agent into the polymer particles. In some embodiments, hydrocarbon blowing agent will be added to the slurry as a liquid. Preferably, the amount of hydrocarbon blowing agent added to the system will be predetermined based on the desired degree of hydrocarbon blowing agent in the expandable beads. The pressure tank may be temperature controlled, for example by a circulating hot water bath. In some embodiments, the pressure tank will be mechanically sealed and pressurized using compressed gas, such as nitrogen.

It was conceived that this invention could replace EPS materials in existing equipment of production plants. The EPS raw material would be replaced by a raw material consisting of the compostable or biobased expandable bead. Hydrocarbon blowing agents were conceived as blowing agents because these are already used in EPS manufacturing, and processes exist to capture and burn the volatile hydrocarbons for fuel. It was desired to minimize the costs required to convert an existing plant from EPS to the new compostable or biobased material.

A key aspect of this invention is the ability to incorporate sufficient amounts of hydrocarbon blowing agent into the matrix of the compostable or biobased polymer such as PLA. For example, PLA does not exhibit the affinity for absorption of pentane that polystyrene exhibits to produce EPS. At room temperature, pentane readily absorbs into solid polystyrene, but this does not occur with PLA. It is therefore necessary to produce a composition of compostable or biobased polymer that allows for the impregnation of hydrocarbon blowing agent. To do this, hydrophobic additives are added to the formulation, although not all hydrophobic additives are favorable. Hydrophobic additives with low hydrophilic-lipophilic balance (HLB) numbers are preferred. Examples of low HLB number hydrophobic additives include Span 60 (sorbitan monostearate, HLB=4.7), Span 80 (Sorbitan oleate, HLB=4), and Span 85 (Sorbitan trioleate, HLB=1.8). Block copolymer nonionic emulsifiers can also be used as hydrophobic additives to improve hydrocarbon blowing agent solubility. An example of a suitable nonionic emulsifier is Unithox 420 ethoxylate (HLB=4) from Baker Petrolite, which is a low molecular weight block copolymer of polyethylene and polyethylene glycol. Biologically derived oils, such as soybean oil or acetylated monoglyceride derived from hydrogenated castor oil, can additionally be used to aid in hydrocarbon blowing agent solubility.

The composition of the compostable or biobased polymer formulation was additionally modified by the use of conventional plasticizers, chain extension agents, cross-linkers, and blends with other thermoplastics to improve other aspects of the processability and foaming capabilities of the resin.

For example, the material compositions listed in Table 1 below were produced using melt processing by twin-screw extrusion. NatureWorks 2002D polylactic acid (PLA), a compostable and biobased polymer, was the main component of all formulations. Additional raw materials included citric acid ester (Citroflex A-2, Vertellus Performance Materials), copolyester elastomer (Neostar FN007, Eastman Chemical), stearic acid surface treated calcium carbonate (Omyacarb FT, Omya North America), sorbitane monostearate (Span 60, Sigma-Aldrich), polyethylene glycol (Carbowax 8000, Dow Chemical), acetylated monoglyceride derived from hydrogenated castor oil Grindsted (Soft-N-Safe, Danisco), dicumyl peroxide (Sigma-Aldrich), ethoxylated nonionic emulsifier (Unithox 450, Baker Petrolite) and a custom maleated PLA. The maleated PLA was produced as a precursor to formulations by melt processing of 3% by mass maleic anhydride, 0.5% by mass dicumyl peroxide, and 96.5% by mass NatureWorks 2002D PLA in an extruder using a constant temperature profile of 180° C.

TABLE 1
Compositions and Percentage Content of Pentane after Impregnation

| | | Pentane |
|---|---|---|
| | | Content |
| | Composition | (wt %) |
| 1 | 100% NatureWorks 2002D PLA (Control Sample) | 2.09 |
| 2 | 100% Maleated PLA | 2.29 |
| 3 | 95% 2002D PLA, 5% Grindstead SoftNSafe | 4.34 |
| 4 | 90% 2002D PLA, 5% Grindstead SoftNSafe, 5% Span 60 | 5.55 |
| 5 | 95% MA-graft PLA, 5% octadecylamine | 4.11 |
| 6 | 80% 2002D PLA, 10% Neostar FN007, 5% Citroflex A-2, 5% | 5.05 |
| | Span 60 | |
| 7 | 65% 2002D PLA, 10% Neostar FN007, 10% Citroflex A-2, | 7.89 |
| | 10% Carbowax 8000, 5% Span 60 | |
| 8 | 74% 2002D PLA, 10% Neostar FN007, 1% Citroflex A-2, 5% | 7.16 |
| | Carbowax 8000, 5% Span 60, 5% Omyacarb FT | |
| 9 | 59% 2002D PLA, 10% Neostar FN007, 1% Citroflex A-2, 5% | 5.77 |
| | Carbowax 8000, 5% Span 60, 20% Omyacarb FT | |
| 10 | 90% 2002D PLA, 5% Span 60, 5% Grindstead Soft N Safe | 5.55 |
| 11 | 79.5% 2002D PLA, 5% Omyacarb FT, 5% Carbowax 8000, | 4.77 |
| | 5% Unithox 450, 5% Span 60, 0.5% dicumyl peroxide | |

The raw materials were fed into the feed throat of a 26 mm, co-rotating, twin-screw extruder (model LTF 26-40 from LabTech Engineering Company, LTD). A constant temperature profile of 180° C. was used. The extrudate was passed through a die to produce a strand, cooled by water or by air, and pelletized. To impregnate the compositions with pentane blowing agent, a pre-weighed sample of pellets were sealed in a pressure vessel in contact with liquid pentane at room temperature. The sample vessels were heated to 80° C. while submerged in a water bath for 2 hours. After two hours, the samples were removed and allowed to cool. The pellets were removed, blotted dry to remove any surface coating of liquid pentane, and weighed. The mass of pentane impregnated into the pellets was calculated by the difference in final and initial mass, and is expressed as a percentage of the sample mass in Table 1. Control samples of NatureWorks 2002D PLA and a maleated PLA are included as reference. The control samples were measured to contain less than 2.5% pentane by mass after impregnation, whereas materials containing the hydrophobic additives greatly increased the mass of pentane incorporated by the impregnation process. The materials listed in Table 1 were subsequently expanded to produce foamed pellets by heating on a hot plate, allowing for liberation of the pentane blowing agent to the gas phase.

The amount of components in the melt processable, compostable or biobased composition may vary depending upon the intended end use application. The compostable or biobased polymer may comprise from about 40 to about 99 percent by weight of the final composition.

The melt processable, compostable or biobased composition of the invention can be prepared by any of a variety of ways. For example, the compostable or biobased polymer, hydrophobic additive, hydrocarbon blowing agent, and optional additives can be combined together by any of the blending means usually employed in the plastics industry, such as with a mixing extruder. The mixing operation is most conveniently carried out at a temperature above the melting point or softening point of the polymer. The resulting melt-blended mixture can be processed into lightweight strands and subsequently cut into pellets using a strand pelletizer. The resulting pellets can be molded into a three-dimensional part using conventional equipment utilized in molding expandable polystyrene.

The invention has been described with references to specific embodiments. While particular values, relationships, materials and steps have been set forth for purposes of describing concepts of the invention, it will be appreciated by persons skilled in the art that numerous variations and/or modifications may be made to the invention as shown in the disclosed embodiments without departing from the spirit or scope of the basic concepts and operating principles of the invention as broadly described. It should be recognized that, in the light of the above teachings, those skilled in the art could modify those specifics without departing from the invention taught herein. Having now fully set forth certain embodiments and modifications of the concept underlying the present invention, various other embodiments as well as potential variations and modifications of the embodiments described herein will obviously occur to those skilled in the art upon becoming familiar with such underlying concept. It is intended to include all such modifications, alternatives and other embodiments insofar as they come within the scope of the invention. It should be understood, therefore, that the invention might be practiced otherwise than as specifically set forth herein. Consequently, the present embodiments are to be considered in all respects as illustrative and not restrictive.

What is claimed is:

1. A composition of matter, comprising:
a compostable or bio-based polymer;
a hydrophobic additive; and
a hydrocarbon blowing agent,
wherein the polymer, additive, and blowing agent are melt processed into an admixture.

2. The composition of claim 1, wherein the hydrophobic additive comprises a maleated coupling agent in combination with a hydrophobic amine.

3. The composition of claim 2, wherein the maleated coupling agent comprises a maleated polylactic acid.

4. The composition of claim 2, wherein the hydrophobic amine comprises a primary amine of a hydrocarbon.

5. The composition of claim 4, wherein the hydrophobic amine is octadecylamine.

6. The composition of claim 2, wherein the hydrophobic amine comprises multiple amine functionalities.

7. The composition of claim 1, wherein the hydrophobic additive is a surfactant with a hydrophilic-lipophilic balance (HLB) number of less than 15.

8. The composition of claim 1, wherein the hydrophobic additive is a nonionic emulsifier.

9. The composition of claim 1, wherein the hydrophobic additive is a biologically derived oil.

10. The composition of claim 1, wherein the hydrophobic additive comprises a derivative of sorbitan.

11. The composition of claim 1, wherein the hydrophobic additive comprises a hydrophobically treated mineral.

12. The composition of claim 1, wherein the hydrophobic additive comprises polyethylene glycol.

13. The composition of claim 1, wherein the hydrophobic additive comprises a citric acid ester.

14. The composition of claim 1, wherein the hydrophobic additive is soluble in low molecular weight hydrocarbons.

15. The composition of claim 14, said low molecular weight hydrocarbons being selected from the group consisting of:
propane;
butane;
pentane;
hexane;
heptane; and
octane.

16. The composition of claim 1, wherein the hydrocarbon blowing agent comprises a low molecular weight hydrocarbon.

17. The composition of claim 16, said hydrocarbon blowing agent being selected from the group consisting of:
propane;
butane;
pentane;
hexane;
heptane; and
octane.

18. A method of forming a composition, the method comprising:
blending a mix, comprising:
a compostable or bio-based polymer; and
a hydrophobic additive; and
processing the mix into a plastic melt admixture;
pelletizing the admixture to produce pellets; and
impregnating the pellets with a hydrocarbon blowing agent.

19. The method of claim 18, said mix further comprising a hydrocarbon blowing agent.

20. The method of claim 18, wherein said step of processing the mix into a plastic melt admixture comprises melt-kneading the mix in an extruder.

21. The method of claim 20, further comprising:
extruding the melt admixture extrudate through a nozzle die attached to an end of the extruder.

22. The method of claim 18, wherein said step of impregnating the pellets with a hydrocarbon blowing agent comprises pressurizing the pellets with a gas in a sealed vessel.

23. The method of claim 22, wherein said gas is selected from the group consisting of:
propane;
butane;
pentane;
hexane;
heptane; and
octane.

24. The method of claim 18, wherein said step of impregnating the pellets with a hydrocarbon blowing agent further comprises heating the pellets to a temperature between 20° C. and 100° C.

25. The method of claim 18, further comprising:
expanding the impregnated pellets by heating to produce a foamed bead.

26. The method of claim 25, further comprising:
moving the beads into a mold; and further expanding and fusing the beads in the mold by application of heat.

27. A method for producing a foamed molded product, comprising the steps of:
creating foamed beads according to the method of claim 25;
bringing the foamed beads under temperature and pressure conditions so that a foamed molded product is obtained.
